(19) United States
(12) Patent Application Publication
(10) Pub. No.: US 2014/0094982 A1
(43) Pub. Date: Apr. 3, 2014

(54) GENERATOR CONTROLLER THAT DETECTS LIQUID

(71) Applicant: KOHLER CO., Kohler, WI (US)

(72) Inventors: Andrew John Sember, Plymouth, WI (US); Patrick Dowell, Sheboygan, WI (US)

(73) Assignee: Kohler Co., Kohler, WI (US)

(21) Appl. No.: 13/630,487

(22) Filed: Sep. 28, 2012

(51) Int. Cl. G06F 1/32

(52) U.S. Cl. 700/295

(57) ABSTRACT

Some embodiments relate to an example power generation system. The power generation system includes an electric generator and a generator controller that operates the generator. The power generation system further includes a sensor that determines the presences of liquid (e.g., water). The sensor exchanges data with the generator controller relating to the presence of liquid in an environment where the sensor is located. The generator may be adapted to be located outside a dwelling and the sensor may be adapted to be located inside the dwelling to identify the presence of a liquid (e.g., water). Embodiments are contemplated where the sensor is actually formed of a plurality of sensors that are positioned in different areas (e.g., different parts of the dwelling).

### TECHNICAL FIELD

Embodiments pertain to a generator controller, and more particularly to a generator controller that detects liquid.

### BACKGROUND

Electric generators are typically used to provide electrical power. One common use of electric generators is as a standby power source. Another common use of electric generators is to provide power at a remote location where utility company power is not available.

One common type of electric generator includes an internal combustion engine. The internal combustion engine drives an electrical alternator that produces alternating electricity.

The operation of the electric generator is typically controlled by a generator controller. One of drawbacks with existing generator controllers is that they are usually limited to controlling functions associated with operating the electric generator.

The most common reason to utilize a standby power source that includes an electric generator is so that a dwelling can still be provided with power when a primary power system (e.g., a utility) fails. One of the reasons that primary power sources fail is due to inclement weather (e.g., storms and/or flooding).

Most dwellings incorporate some form of pump to remove unwanted water from the dwelling when the water enters the dwelling from a storm and/or flooding. These pumps are typically powered by the electric generator when the primary power source is unable to provide power.

One of drawbacks with existing pumps is that they usually require relatively expensive additional electronic modules if any type of control or monitoring is to be provided for the pump. In addition, there is little or no communication (or control) between the pump and the generator controller that operates the electric generator (which happens to be the device that is needed to provide power to the pump when the primary power source fails).

### BRIEF DESCRIPTION OF THE DRAWINGS

FIG. 1 is a schematic view illustrating a power generation system that is capable of detecting liquid according to an example embodiment.

FIG. 2 is a schematic view illustrating the example power generation system shown in FIG. 1 where the power generation system includes a programmable interface module.

FIG. 3 is a schematic view illustrating the example power generation system shown in FIG. 2 where the power generation system is incorporated into a dwelling.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

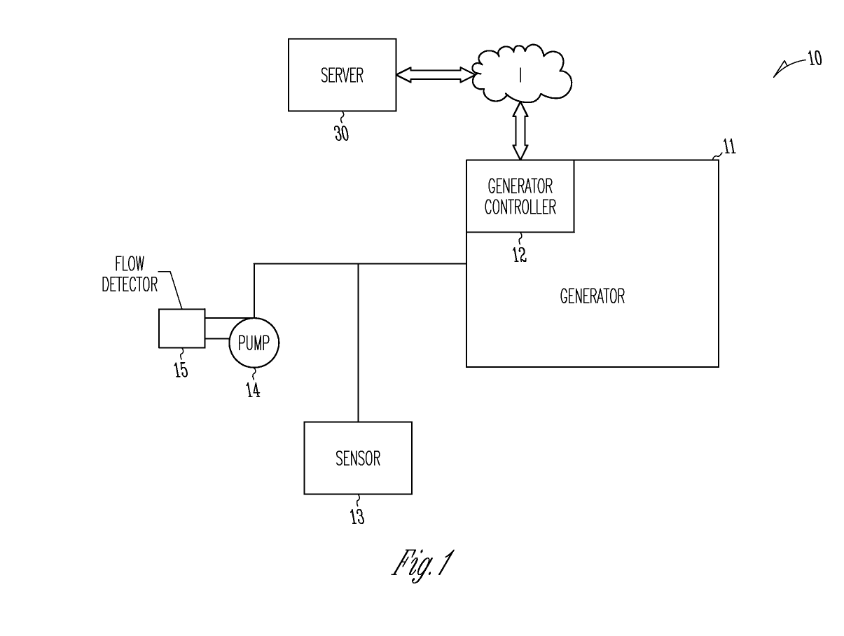

FIG. 1 is a schematic view illustrating an example power generation system 10. The power generation system 10 includes an electric generator 11 and a generator controller 12 that operates the generator 11. The power generation system 10 further includes a sensor 13 that determine the presences of liquid (e.g., water). The sensor 13 exchanges data with the generator controller 12 relating to the presence of liquid in an environment where the sensor 13 is located.

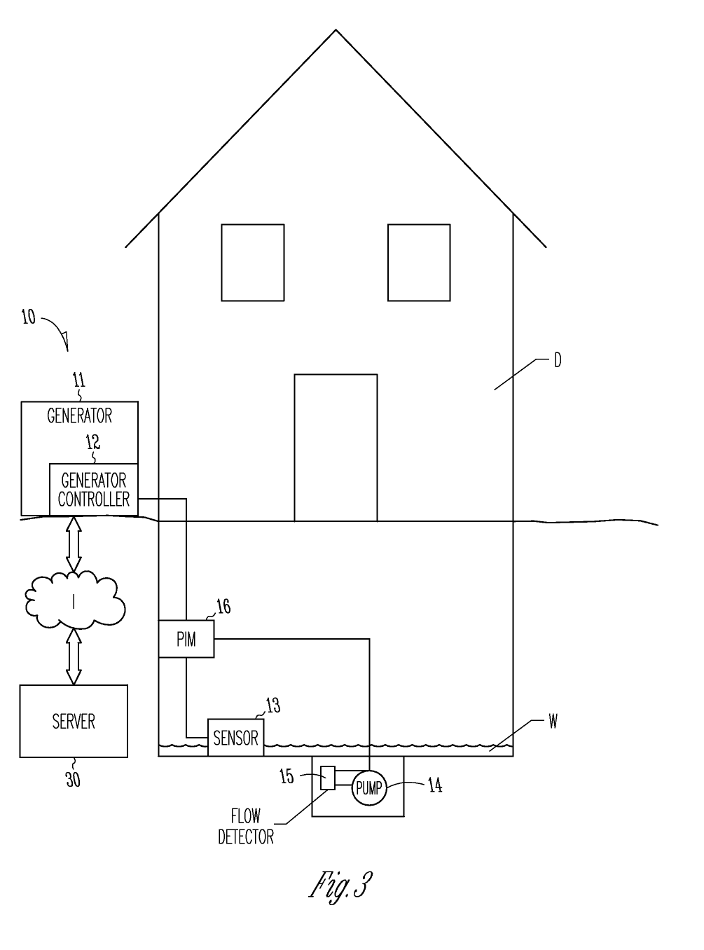

As shown in FIG. 3, the generator 11 may be adapted to be located outside a dwelling D and the sensor 13 may be adapted to be located inside the dwelling D to identify the presence of a liquid (e.g., water W). Embodiments are contemplated where the sensor 13 is actually formed of a plurality of sensors (not shown) that are positioned in different areas (e.g., different parts of the dwelling D).

It should be noted that any type of sensor 13 that is known now, or discovered in the future, may be included in the example power generation systems 10 described herein. The type of sensor 13 that is included in the power generation system 10 will depend in part on cost and/or the application where the power generation system 10 will be used.

As an example, the sensor 13 may include a first conductor (not shown) and a second conductor (not shown). The first and second conductors may be oriented such that when the first and second conductors are immersed in a liquid a signal is passed from the first conductor to the second conductor.

In the illustrated example embodiments, the power generation system 10 further includes a pump 14 that exchanges signals with the generator controller 12. In some embodiments, the generator controller 12 operates the pump 14. The type of pump 14 (or pumps) that are included in the power generation system 10 will depend in part on cost and/or the application where the power generation system 10 will be used.

In the illustrated example embodiments, the power generation system 10 further includes a flow detector 15 that detects liquid flowing from the pump 14. The flow sensor 15 exchanges data with the generator controller 12 relating to the flow of liquid from the pump 14. The type of flow detector 15 that is included in the power generation system 10 will depend in part on cost and/or the application where the power generation system 10 will be used.

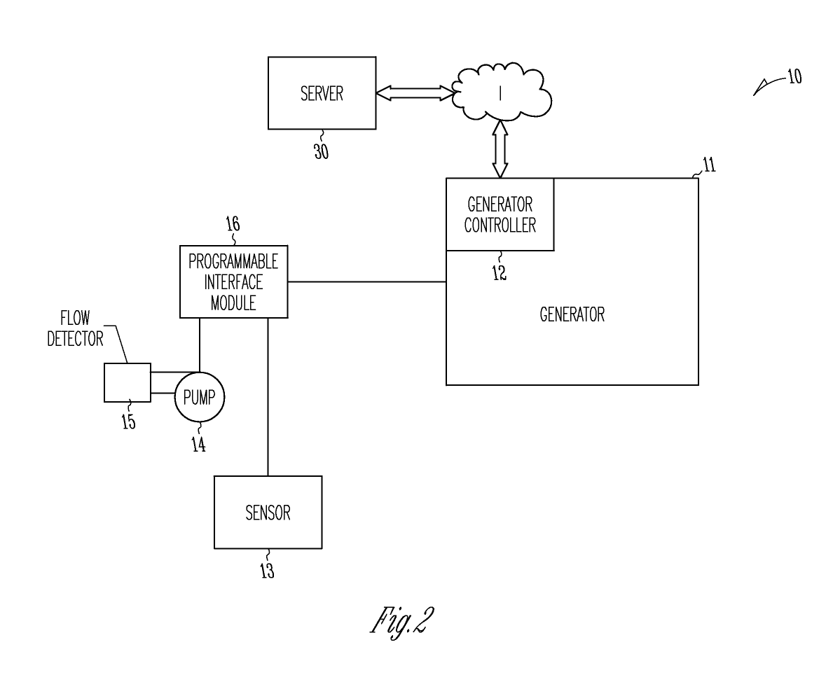

In the example embodiment that is illustrated in FIGS. 2 and 3, the power generation system 10 further includes a programmable interface module 16 that exchanges signals with the sensor 13 and the generator controller 12. In addition, the programmable interface module 16 may exchange signals with the pump 14 such that the programmable interface module 16 operates the pump 14.

In some embodiments, the programmable interface module 16 includes a sensor circuit (not shown) that converts an input signal received from the sensor 13 (and/or flow detector 15) for delivery to the generator controller 12. In addition, the sensor circuit may include an output circuit (not shown) that transmits an output signal received from the generator controller 12 for transmission to the pump 14.

It should be noted that the generator controller 12 may include a power source (not shown) that supplies power to operate the programmable interface module 16. As an example, the power source may be a 12V direct current power source, although it should be noted that other sources for powering the programmable interface module 16 are contemplated.

In addition, the power source may be regulated by the generator controller 12. It should be noted that the generator controller 12 may regulate power to the programmable interface module 16 when there is loss of a primary power source (not shown). Therefore, the loss of the primary power source would not affect operation of the programmable interface module 16.

In some embodiments, the generator controller 12 may be configured to provide data to a user via a network. As an example, the power generation system 10 may further include a server 30 that is connected to the generator controller 12 via a network (e.g., the Internet I). It should be noted that the generator controller 12 may be connected to the network in a hard-wired or wireless manner.

The generator controller 12 may be configured to exchange data with the server 30. As an example, the server 30 may provide notification to a user as to the presence of a liquid when the generator controller 12 provides data to the server 30 that the sensor 13 has detected liquid.

In addition, the server 30 may be configured to provide commands from a user to the generator controller 12 via the server 30 relating to operation of the pump 14. As an example, the generator controller 12 may be configured to receive commands from the server to activate (or deactivate) the pump 14.

Embodiments are contemplated where the generator controller 12 may be configured to receive signals at a user interface (not shown) and/or send commands from the user interface. In some embodiments, the user interface is mounted to the generator controller 12. The user interface may include a keyboard and/or a display that are configured to facilitate interaction with one or more of the sensor 13, pump 14, flow detector 15 and/or programmable interface module 16.

In some embodiments, the generator controller 12 may be configured to store data related to the operation of any of the sensor 13, pump 14, flow detector 15 and/or programmable interface module 16 that are included in the power generation system 10. In addition, the generator controller 12 may store and utilize data relating to (i) generator control functions (e.g., start and stop); (ii) load switching functions (e.g., timers to activate the power switching devices); and/or (iii) programmable interface module 16 connections (e.g., inputs and/or outputs to the programmable interface module 16).

The power generation systems 10 described herein utilize a standby power source that includes an electric generator to provide power to a dwelling when a primary power system (e.g., a utility) fails (e.g., due to storms and/or flooding).

The power generation systems 10 described herein also include a generator controller 12 that controls both a standby electric generator and a pump 14 that may be used to remove unwanted water from the dwelling when the water enters the dwelling from a storm and/or flooding. Therefore, the power generation systems 10 described herein do not require the relatively expensive additional electronic modules that are typically used to provide control for the pump.

In addition, the power generation systems 10 provide communication between the pump 14 and the generator controller 12 that operates the electric generator which provides power to the pump 14 when the primary power source fails.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A power generation system that is capable of detecting liquid, the power generation system comprising:
a generator;
a generator controller that operates the generator; and
a sensor that determine the presences of liquid, wherein the sensor exchanges data with the generator controller relating to the presence of liquid in an environment where the sensor is located.

2. The power generation system of claim 1, further comprising a pump that exchanges signals with the generator controller.

3. The power generation system of claim 1, wherein the generator controller operates the pump.

4. The power generation system of claim 3, further comprising a flow sensor that detects liquid flowing from the pump, wherein the flow sensor exchanges data with the generator controller relating to the flow of liquid from the pump.

5. The power generation system of claim 4, wherein the generator controller shuts off the pump when no flow of liquid is detected when there should be flow through the pump.

6. The power generation system of claim 1, wherein the sensor includes a first conductor and a second conductor such that when the first and second conductors are immersed in a liquid a signal is passed from the first conductor to the second conductor.

7. The power generation system of claim 1, further comprising a programmable interface module that exchanges signals with the sensor and the generator controller.

8. The power generation system of claim 7, further comprising a pump that exchanges signals with the programmable interface module.

9. The power generation system of claim 8, wherein the programmable interface module operates the pump.

10. The power generation system of claim 9, wherein the programmable interface module includes a sensor circuit that converts an input signal received from the sensor for delivery to the generator controller, and wherein the sensor circuit includes an output circuit that transmits an output signal received from the generator controller for transmission to the pump.

11. The power generation system of claim 7, wherein the generator controller includes a power source that supplies power to operate the programmable interface module.

12. The power generation system of claim 11, wherein the power source is a 12V direct current power source.

13. The power generation system of claim 1, wherein the sensor determines the presence of water.

14. The power generation system of claim 1, wherein the generator is adapted to be located outside a dwelling and the sensor is adapted to be located inside the dwelling.

15. The power generation system of claim 1, wherein the generator controller is configured to provide data to a user via a network.

16. The power generation system of claim 15, further comprising a server that is connected to the generator controller via a network, wherein the generator controller is configured to exchange data with the server.

17. The power generation system of claim 16, wherein the network is the Internet.

18. The power generation system of claim 17, wherein the server provides notification to a user as to the presence of a liquid when the generator controller provides data to the server that the sensor has detected the liquid.

19. The power generation system of claim 18, further comprising a pump that exchanges signals with the generator controller, wherein the server is configured to provide commands from a user to the generator controller relating to operation of the pump.

20. The power generation system of claim 1, wherein the generator controller is configured to store data relating to operation of the sensor.
